(19) United States
(12) Patent Application Publication
(10) Pub. No.: US 2026/0054442 A1
(43) Pub. Date: Feb. 26, 2026

(54) DEVICE FOR A FUEL TANK FOR A MOTOR VEHICLE

(71) Applicant: PLASTIC OMNIUM ADVANCED INNOVATION AND RESEARCH, Bruxelles (BE)

(72) Inventors: Laurent DUEZ, Bruxelles (BE); Antoine CHAUSSINAND, Bruxelles (BE); Christoph FASSMANN, Bruxelles (BE); Jules-Joseph VAN SCHAFTINGEN, Bruxelles (BE); Tae-Gwon KIM, Bruxelles (BE)

(73) Assignee: PLASTIC OMNIUM ADVANCED INNOVATION AND RESEARCH, Bruxelles (BE)

(21) Appl. No.: 19/102,659

(22) PCT Filed: Aug. 10, 2023
(86) PCT No.: PCT/EP2023/072224

§ 371 Date: Feb. 10, 2025

(30) Foreign Application Priority Data
Aug. 16, 2022 (BE) BE20225639

(51) Int. Cl. B29C 49/04; B29C 49/20; B29L 31/00; B60K 15/03

(52) U.S. Cl. CPC B29C 49/04118; B29C 49/20; B60K 15/03177; B29C 2049/2008; B29C 2049/2073; B29L 2031/7172; B60K 2015/03032; B60K 2015/03328

(57) ABSTRACT

A device is for a plastic gasoline tank for a motor vehicle. The device includes a frame, an internal reinforcing element of a gasoline system, and a movable support of the component. The movable support is attached to the frame and movable relative to the frame between an initial configuration in which the reinforcing element is at a first distance from the frame and a final configuration in which the reinforcing element is at a second distance from the frame. The first distance is smaller than the second distance. The frame is provided with a structure for stopping the movement of the movable support when the movable support is in the final configuration.

The invention relates to the technical field of devices for plastic fuel tanks for motor vehicles and plastic fuel tanks for motor vehicles containing such devices. More particularly, the invention relates to a device for a plastic fuel tank for a motor vehicle comprising a frame, a component, and at least one movable support means of the component. Throughout the description herein, it is understood that the term “fuel” means “gasoline”, i.e., a fuel according to standard EN228, composed of a mixture of light hydrocarbons, predominantly C₇H₁₆.

The invention also relates to a method for manufacturing a plastic fuel tank for a motor vehicle.

Conventionally, plastic fuel tanks for motor vehicles are obtained by extrusion blow-molding of a parison. The extruded parison generally has a tubular shape, with most of the internal components of the fuel system inserted within it during the extrusion blow-molding process. Because of the complexity of the arrangement of the internal components, these are generally inserted using a device comprising a frame incorporating these components, as disclosed in WO2022073964 A1.

However, this results in a limitation of the size of the device comprising the frame inserted inside the tubular parison. Indeed, the extruded tubular parison generally has a defined diameter. As a result, the device that can be inserted into the tubular parison must be inserted in a circle with a diameter smaller than the internal diameter of the tubular parison, which limits the positioning of the inserted components once the tank has been blown, the resulting tank having an internal cavity with dimensions greater than the internal diameter of the tubular parison.

In particular, the aim of the invention is to overcome these disadvantages of the prior art.

To this end, the aim of the invention is to provide a device for a plastic fuel tank for a motor vehicle comprising a frame with at least one component of a fuel system having easy insertion within a tubular parison during the manufacture of a plastic fuel tank.

In at least one of its embodiments, the invention also has the aim of providing a plastic fuel tank for a motor vehicle.

Another aim of the invention, in at least one of its embodiments, is to implement a method for manufacturing a plastic fuel tank for a motor vehicle.

In accordance with one particular embodiment, the invention relates to a device for a plastic fuel tank for a motor vehicle.

According to the invention, such a device comprises at least one frame, a fuel system component and at least one movable support means of the fuel system component, said movable support means of the fuel system component being attached to the frame and movable relative to the frame between an initial configuration in which the fuel system component is at a first distance, d₁, from the frame and a final configuration in which the fuel system component is at a second distance, d₂, from the frame, such that the first distance, d₁, is smaller than the second distance, d₂, the frame being provided with a means for stopping the movement of the movable support means of the fuel system component when the movable support means of the fuel system component is in the final configuration.

According to the invention, the fuel system component is an internal reinforcing element, and the fuel is gasoline.

The general principle of the invention is based, on the one hand, on the presence of a movable support means that is attached to the frame and movable relative to the frame between an initial configuration in which the fuel system component it supports is at a first distance, d₁, from the frame and a final configuration in which the fuel system component is at a second distance, d₂, from the frame, such that the first distance, d₁, is smaller than the second distance, d₂, and, on the other hand, on the presence on the frame of a means for stopping the movement of the movable support means of the fuel system component when the movable support means of the fuel system component is in the final configuration.

Thus, the invention is based on a completely novel and inventive approach to a device comprising a frame, a fuel system component and at least one movable support means of the fuel system component, said movable support means of the component being movable relative to the frame between an initial configuration in which the fuel system component is at a first distance, d₁, from the frame and a final configuration in which the fuel system component is at a second distance, d₂, from the frame, such that the first distance, d₁, is smaller than the second distance, d₂, the frame being provided with a means for stopping the movement of the movable support means of the fuel system component when the movable support means of the fuel system component is in the final configuration. Such a device allows for easy insertion within a tubular parison and leads to an increase in tank production speed by avoiding contact between the frame containing the internal components of the fuel tank and the tubular parison. In addition, such a device also allows the fuel system components to be positioned within the fuel tank at the point most suited to the function they are to perform, so that internal reinforcing elements can be positioned at the point subject to the greatest stress, or valves of the ventilation system can be located at a point that reduces the loss of useful volume.

Finally, such a device makes it possible to reduce the number of interventions on the fuel tank after the extrusion blow-molding operation, such as attaching fuel system components far out of line with the frame, and thus to reduce the number and size of openings to be provided in the tank wall in order to carry out such interventions, leading to a reduction in hydrocarbon emissions through said openings.

The expression “an initial configuration in which the fuel system component is at a first distance, d₁, from the frame and a final configuration in which the fuel system component is at a second distance, d₂, from the frame, such that the first distance, d₁, is smaller than the second distance, d₂” means that in the initial configuration, the frame and the component occupy a first peripheral volume V1, and that in the final configuration, the frame and the component occupy a second peripheral volume V2, and the peripheral volume V2 is greater than the peripheral volume V1. The distance d₁ is inserted in the volume V1, and the distance d₂ is inserted in the volume V2. In each configuration, the peripheral volume is delimited by the peripheral points of the frame and of the component, i.e., the points thereof that are furthest, in a given direction, from the geometric center (C) of the device. In the above definition of the peripheral volume, depending on the shape of the device, in the event that the term “geometric center” of the device is difficult to define for a person skilled in the art, in particular where there is no center of symmetry or part globally assimilated to a center of symmetry of the device, the geometric center can be defined as follows: considering a median longitudinal plane (X; Y) of the device (i.e., a longitudinal plane that divides the device into two parts of similar volume), the geometric center (C) shall be understood to be the midpoint of the longest segment (S) of the device in this median longitudinal plane. In the event that the latter definition still leaves a person skilled in the art with difficulty in defining the geometric center of the device, the geometric center shall be understood to correspond to the barycenter of the device. The distances d₁ and d₂ are the shortest distances between a main part of the frame and a peripheral point of the component along a transverse plane (Y; Z) of the device.

It is understood that the initial configuration is the tank insertion configuration, and the final configuration is the operating configuration. It is further understood that, in the initial configuration, the device has dimensions in longitudinal planes (X; Y) of the device, perpendicular to the vertical axis (Z) of the tank and to the axis of the parison, allowing it to be inserted in a circle with a diameter smaller than the internal diameter of the tubular parison. In the final configuration, the device has the same longitudinal planes (X; Y) of the device, with dimensions allowing it to be positioned in the internal cavity of the tank.

The term “fuel system component” relates to a component selected from a ventilation line, a fuel line, a pump, a level sensor, a pressure sensor, a temperature sensor, a quality sensor, a deflector, an internal reinforcing element or a valve such as a flap, a roll-over valve (ROV) or a fill limit vent valve (FLVV).

For the purposes of this invention, “internal” means an element located within the internal volume of the tank, suitable for being in contact with the gasoline contained in the tank.

The internal reinforcing element has the object of increasing the ability of the plastic tank to withstand the mechanical stresses to which it is subjected over its life.

Preferably, the distance d₁ and the distance d₂ are measured along a longitudinal plane (X; Y) perpendicular to the vertical axis (Z) of the device, corresponding to the vertical axis of the internal cavity of the fuel tank, when the device is housed therein.

According to one preferred embodiment, the device for a plastic fuel tank for a motor vehicle according to the invention is such that the movable support means of the fuel system component is translationally and/or rotationally movable with respect to the frame. A combination of translational and rotational mobility relative to the frame is illustrated, for example, by a pantograph-type movement.

Thus, a movable support means of the fuel system component that is translationally and/or rotationally movable relative to the frame provides a good degree of freedom in the arrangement of the fuel system component within the tank and also makes it easier to take account of the complexity of the shape of the fuel tank.

According to one preferred embodiment of the preceding embodiment, the device for a plastic fuel tank for a motor vehicle according to the invention is such that the movable support means of the fuel system component is rotationally movable relative to the frame.

Thus, a movable support means of the fuel system component that is rotationally movable relative to the frame avoids the use of a mechanically or electrically actuated device but instead uses gravity to drive the movement of the movable support means.

According to a further aim of the invention, the device for a plastic fuel tank for a motor vehicle according to the invention is such that the fuel system component is selected from an internal reinforcing element, a valve, and a sensor.

Thus, a fuel system component selected from an internal reinforcing element, a valve, and a sensor makes it possible, in the case of an internal reinforcing element, to position it at the point subject to the greatest stress, in the case of a valve, preferentially a valve of the ventilation system, to locate it at a point such as to reduce the loss of useful volume, and in the case of a sensor, to carry out a measurement at a desired point. The internal reinforcing element is in the form of a column, preferentially cylindrical, or in the form of a diabolo, as described, for example, in EP2865553. The column can be straight or have a curved shape, as described, for example, in EP3878676. The reinforcing element can also comprise a plurality of such columns, linked together by a connecting means in the form of a connecting rod, for example. The internal reinforcing element can also be in the form of a holding member comprising a wall provided with a central recess, a part of the wall comprising reinforcing ribs. The wall of the holding member can be planar or curved. It can also take the form of a structure having a central part with a cross-section in the shape of a crown sector, defining a principal axis of the reinforcing element and having a first area, the principal axis passing through the center of rotation of the crown sector perpendicular to the crown sector, the central part preferentially comprising a network of ribs extending radially with respect to the principal axis, said network of radial ribs, and two axial end portions located on either side of the central part with respect to the main axis, each of the axial end portions having an oblong, curved end surface, inserted in the cross-section of the central part, having a second area preferentially smaller than the first area. In the case of a columnar or diabolo-shaped internal reinforcing element, the latter is preferentially made up of a central part based on a material selected from polyoxymethylene (POM), polyphthalamide (PPA), polyketone (PK), polyamide (PA), and metal, and the two ends of the central part are overmolded with high-density polyethylene (HDPE). The sensor can be a level, temperature, pressure, or quality sensor.

According to one preferred embodiment, the device for a plastic fuel tank for a motor vehicle according to the invention is such that the frame comprises means for locking the movable support means of the fuel system component so that the movable support means of the fuel system component is locked in the initial configuration.

Thus, a means for locking the movable support means of the fuel system component when the movable support means of the fuel system component is in the initial configuration allows for easier handling of the device when it is inserted into the tubular parison.

In one embodiment, the means for locking the movable support means in the initial configuration included in the frame is in the form of a first rib on the frame. This first rib is suitable for bearing against a second rib on the movable support means. Thus, in this embodiment, the device is locked in the initial configuration by direct interaction of a locking means of the frame with a locking means of the movable support means, which is a simple way of locking the component in the initial configuration.

According to one preferred embodiment, the device for a plastic fuel tank for a motor vehicle according to the invention is such that the movable support means of the fuel system component comprises a central part, preferentially in the form of a rod, a first end suitable for interacting with an insertion means, such as an insertion rod, for example, and a second end provided with an attachment means of the fuel system component.

According to one preferred embodiment, the device for a plastic fuel tank for a motor vehicle according to the invention is such that the frame comprises a receiving member suitable for receiving an insertion means, such as an insertion rod, for example.

In one embodiment, the first end of the movable support means is suitable for interacting with the insertion means so that the removal of the insertion means causes the movable support means to move towards its initial configuration. Thus, the removal of the insertion means automatically moves the movable support means to its final configuration.

Optionally, the movable support means is configured so that the first end bears against a part of the insertion means, so that when the insertion means is removed, the movable support means is rotated by gravity.

Optionally, the movable support means is configured so that the first end is hooked to a part of the insertion means so that the driving force of the movement to remove the insertion means allows the movable support means to be set in motion, for example by rotation about a hinge-type mechanism.

Optionally, the first end of the movable support means is suitable for being attached to an actuator provided on part of the insertion means so that the movable support means is set in motion by the driving force of the actuator during the movement to remove the insertion means.

In one embodiment, the stopping means is in the form of a third rib on the frame, and a fourth rib on the movable support means is suitable for abutting against the third rib. The stopping is achieved by deformation, similar to clipping, of the fourth rib. The movable support means can be moved relative to the frame by rotation about a hinge-type mechanism.

Preferentially, the frame is based on a material selected from the group of materials consisting polyethylene (PE), preferentially high-density polyethylene (HDPE), polyoxymethylene (POM), polyamide (PA), polyphthalamide (PPA) and polyketone (PK). The frame can also support fuel system components such as vent and fuel lines, a pump, a level sensor, a pressure sensor, a temperature sensor, a deflector, an internal reinforcing element, or a valve such as a flap, a Roll-Over Valve (ROV) or a fill limit vent valve (FLVV). Preferentially, the frame is in the form of a framework, preferentially a single-piece framework. Preferentially, the framework is in the form of a structure comprising at least four sides defining the periphery of the frame.

Another aim of the invention is to provide a method for manufacturing a plastic fuel tank for a motor vehicle.

According to an advantageous implementation of the method for manufacturing a plastic fuel tank for a motor vehicle according to the invention, said method is such that it comprises at least the following steps:
Extruding a tubular parison,
Inserting a device for a plastic fuel tank for a motor vehicle according to the invention within the tubular parison, said device being in an initial configuration in which the fuel system component is at a first distance, d₁, from a frame,
   Deploying the device from the initial configuration in which the fuel system component is at a first distance, d₁, from the frame to a final configuration in which the fuel system component is at a second distance, d₂, from the frame, such that the first distance, d₁, is smaller than the second distance, d₂.
Stopping the deployment of the device when it reaches its final configuration, using the stopping means provided on the frame.

According to a preferred implementation of the method for manufacturing a plastic fuel tank for a motor vehicle according to the invention, the step of inserting the device within the tubular parison is carried out using an insertion means, such as an insertion rod.

According to a preferred implementation of the method for manufacturing a plastic fuel tank for a motor vehicle according to the invention, the step of deploying the device is carried out by translating and/or rotating a movable support means of the fuel system component relative to the frame. Preferentially, the step of deploying the device is initiated upon removal of the insertion means, more preferentially by the removal of the insertion means. The term “removal the insertion means” relates to the retraction of the insertion means out of the parison, the insertion means not remaining in the tank obtained at the end of its manufacture. The insertion means is removed before the parison is blown to give the tank its final shape within the mold.

According to a preferred implementation of the method for manufacturing a plastic fuel tank for a motor vehicle according to the invention, the step of deploying the device is carried out by rotating the movable support means of the fuel system component relative to the frame. Preferentially, the movable support means is rotated by gravity or by a mechanical means upon removal of the insertion means. When the movable support means is rotated by gravity, rotation is initiated by the weight of the movable support means and the component upon removal of the insertion means. Advantageously, the insertion means is an insertion rod provided with a holding notch on which a part of the movable support means is locked when the device is in the initial configuration. It is the movement to remove the insertion rod that releases the movable support means from the notch, causing it to rotate under gravity. Alternatively, the movable support means is rotated by a mechanical means upon removal of the insertion means. Advantageously, the mechanical means consists of the insertion means provided with a means for clipping the movable support means.

According to a preferred implementation of the method for manufacturing a plastic fuel tank for a motor vehicle according to the invention, the step of deploying the device from the initial configuration to the final configuration is carried out by translating the movable support means of the component relative to the frame. Preferentially, the movable support means is translated by a mechanical means upon removal of the insertion means. The mechanical means consists of the insertion means, and a guide means for the movable support means. Alternatively, the mechanical means consists of a transverse actuator.

According to a preferred implementation of the method for manufacturing a plastic fuel tank for a motor vehicle according to the invention, the method comprises a step of locking the movable support means when the device is in its final position. This locking step can be carried out using the stopping means provided on the frame.

Another aim of the invention is to provide a plastic fuel tank for a motor vehicle, comprising a device for a plastic tank for a motor vehicle according to the invention.

Other features and advantages of the invention will become more clearly apparent upon reading the following description of a preferred embodiment, given by way of simple, illustrative, and non-limiting example, and from the appended drawings, in which:

FIG. 1 shows a device for a plastic fuel tank for a motor vehicle according to the invention in the initial configuration,

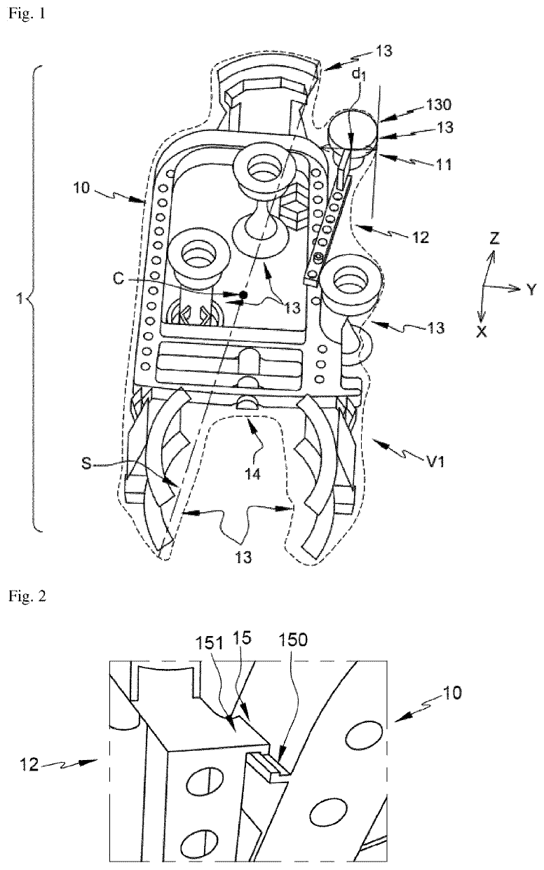

FIG. 2 describes a means for locking a movable support means of a device according to the invention when the device is in the initial configuration,

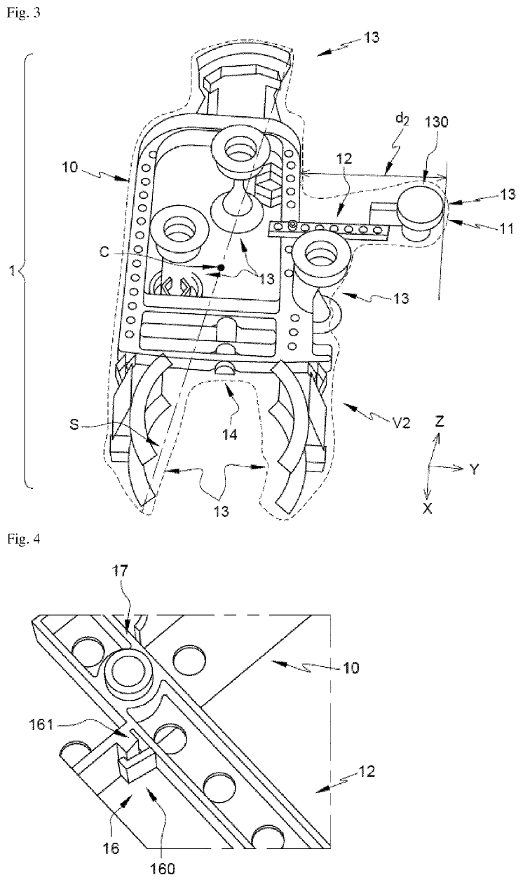

FIG. 3 illustrates a device for a plastic fuel tank for a motor vehicle according to the invention in the final configuration,

FIG. 4 shows a means for stopping the movement of the movable support means of a device according to the invention when the device is in the final configuration,

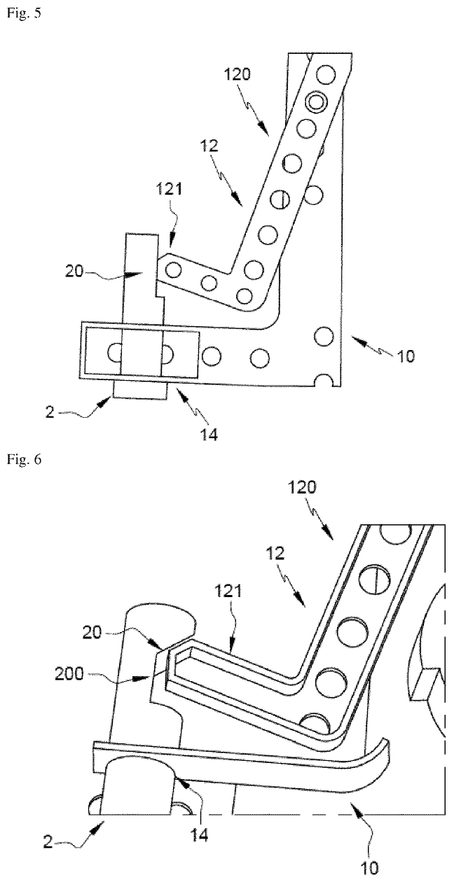

FIG. 5 illustrates a first alternative to the locking means for locking the movable support means of the fuel system component shown in FIG. 2 when the device is in the initial configuration,

FIG. 6 describes a second alternative to the locking means for locking the movable support means of the fuel system component shown in FIG. 2 when the device is in the initial configuration,

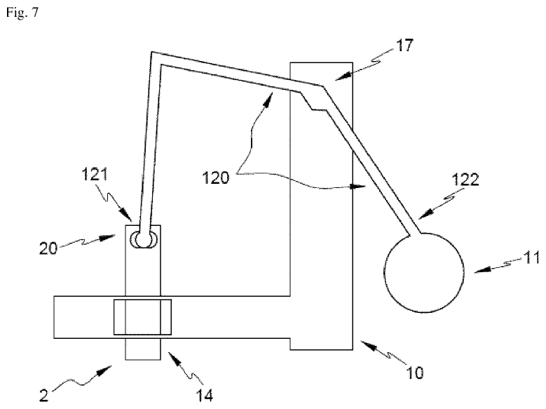

FIG. 7 describes a third alternative to the locking means for locking the movable support means of the fuel system component shown in FIG. 2 when the device is in the initial configuration,

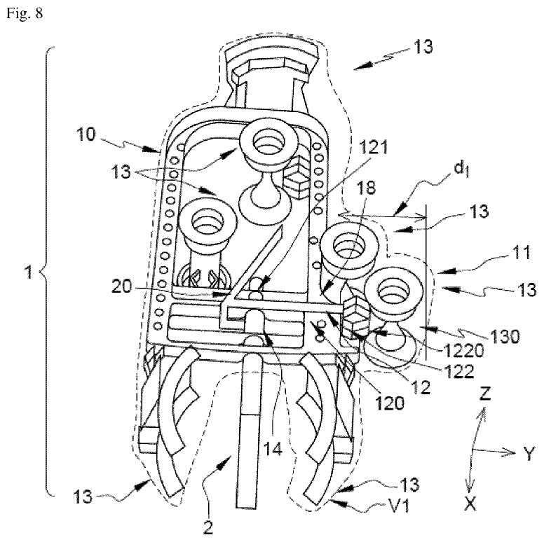

FIG. 8 describes a device for a plastic fuel tank for a motor vehicle according to the invention in the initial configuration,

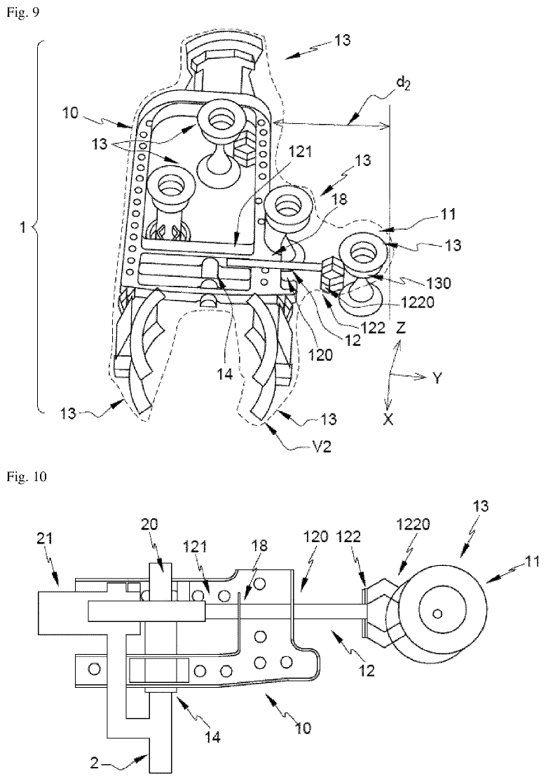

FIG. 9 describes a device for a plastic fuel tank for a motor vehicle in the final configuration,

FIG. 10 describes a fourth alternative to the locking means for locking the movable support means of the fuel system component shown in FIG. 2 when the device is in the initial configuration,

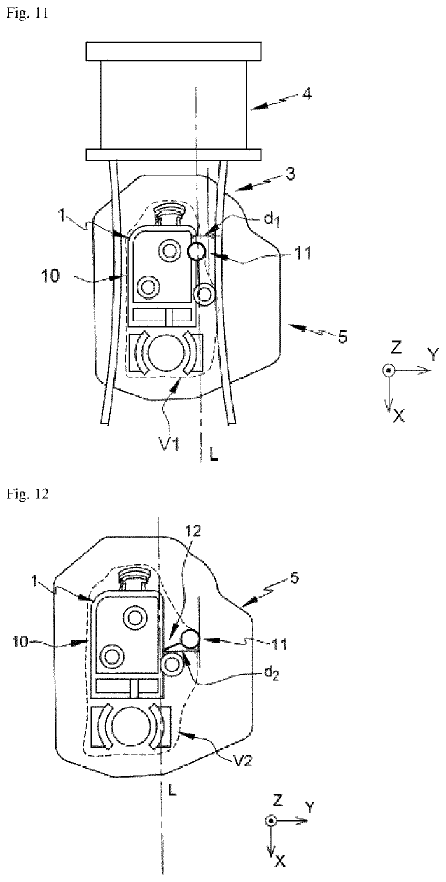

FIGS. 11 and 12 illustrate, respectively, the step of inserting the device in the initial configuration within the tubular parison and the device in the final configuration within the plastic fuel tank for a motor vehicle.

FIG. 1 shows an embodiment of a device 1 for a plastic fuel tank for a motor vehicle according to the invention. The device comprises at least one frame 10, a fuel system component 11, and at least one movable support means 12 of the fuel system component 11, said movable support means 12 of the fuel system component 11, being attached to the frame and movable relative to the frame between an initial configuration, in which the fuel system component is at a first distance, d₁, from the frame and a final configuration in which the fuel system component is at a second distance, d₂, from the frame, such that the first distance, d₁, is smaller than the second distance, d₂. The device has a longitudinal direction along a plane (X; Y) and a height along the Z-axis. Since the device shown in FIG. 1 is asymmetrical, a geometric center (C) of the device is shown in a median longitudinal plane (X; Y) of the device (i.e., a longitudinal plane cutting the device into two parts of similar volume). The geometric center (C) is the midpoint of the longest segment(S) of the device in this median longitudinal plane. A peripheral volume (V1, V2) is shown, which is delimited by the peripheral points of the frame and of the component, i.e., the points thereof that are furthest, in a given direction, from the geometric center (C) of the device. In the initial configuration (FIG. 1), the frame and the component occupy a first peripheral volume V1, and in the final configuration (FIG. 3), the frame and the component occupy a second peripheral volume V2, and the peripheral volume V2 is greater than the peripheral volume V1. The distance d₁ is inserted in the volume V1, and the distance d₂ is inserted in the volume V2. The distances d₁ and d₂ are the shortest distances between a main part of the frame and a peripheral point of the component along a transverse plane (Y; Z) of the device. The device shown in FIG. 1 is in the initial configuration. The frame 10 is provided with a means (not shown) for stopping the movement of the movable support means 12 of the fuel system component 11 when the movable support means 12 of the fuel system component 11 is in the final configuration. The frame 10 is also provided with a means (not shown) for locking the movable support means 12 of the fuel system component 11 when the movable support means 12 of the fuel system component 11 is in the initial configuration. The component 11 of the fuel system is an internal reinforcing element 13 in the form of a diabolo 130 consisting of a central part based on a material selected from polyoxymethylene (POM), polyphthalamide (PPA), polyketone (PK), polyamide (PA), and metal, the two ends of the central part being overmolded with high-density polyethylene (HDPE). The frame 10 is in the form of a framework made of a material selected from polyethylene (PE), preferentially high-density polyethylene (HDPE), polyoxymethylene (POM), polyamide (PA), polyphthalamide (PPA), and polyketone (PK). The frame 10 also supports components of the fuel system such as vent lines, fuel lines, a pump, a level sensor, a pressure sensor, a temperature sensor, a quality sensor, a deflector, an internal reinforcing element 13 or a valve such as a flap, a roll-over valve (ROV), or a fill limit vent valve (FLVV). The frame 10 also includes a receiving member 14 suitable for receiving an insertion means, such as an insertion rod, for example. This receiving member 14 is preferentially in the form of a sheath suitable for allowing the insertion means to slide.

FIG. 2 shows, in relation to FIG. 1, an embodiment of a locking means 15 for locking the movable support means 12 of the fuel system component, when the movable support means 12 of the fuel system component is in the initial configuration. The locking means 15 is in the form of a first rib 150 on the frame 10, bearing against a second rib 151 on the movable support means 12.

FIG. 3 illustrates the device 1 for a plastic fuel tanks for a motor vehicle shown in FIG. 1. The device comprises at least one frame 10, a fuel system component 11, and at least one movable support means 12 of the fuel system component 11, said movable support means 12 of the fuel system component 11, being attached to the frame and movable relative to the frame between an initial configuration, in which the fuel system component is at a first distance, d₁, from the frame and a final configuration in which the fuel system component is at a second distance, d₂, from the frame, such that the first distance, d₁, is smaller than the second distance, d₂. The device shown in FIG. 2 is in the final configuration. The frame 10 is provided with a means (not shown) for stopping the movement of the movable support means 12 of the fuel system component 11 when the movable support means 12 of the fuel system component 11 is in the final configuration. The frame 10 is also provided with a means (not shown) for locking the movable support means 12 of the fuel system component 11 when the movable support means 12 of the fuel system component 11 is in the initial configuration. The component 11 of the fuel system is an internal reinforcing element 13 in the form of a diabolo 130 consisting of a central part based on a material selected from polyoxymethylene (POM), polyphthalamide (PPA), polyketone (PK), polyamide (PA), and metal, the two ends of the central part being overmolded with high-density polyethylene (HDPE). The frame 10 is in the form of a framework made of a material selected from polyethylene (PE), preferentially high-density polyethylene (HDPE), polyoxymethylene (POM), polyamide (PA), polyphthalamide (PPA), and polyketone (PK). The frame 10 also supports components of the fuel system such as fuel line ventilation lines, a pump, a level sensor, a pressure sensor, a temperature sensor, a quality sensor, a deflector, an internal reinforcing element 13 or a valve such as a flap, a roll-over valve (ROV) or a fill limit vent valve (FLVV). The frame 10 also includes a receiving member 14 suitable for receiving an insertion means, such as an insertion rod, for example. This receiving member 14 is preferentially in the form of a sheath suitable for allowing the insertion means to slide.

In relation to FIG. 3, FIG. 4 shows an embodiment of a means 16 for stopping the movement of the movable support means 12 of the fuel system component when the movable support means 12 of the fuel system component is in the final configuration. The stopping means 16 is in the form of a third rib 161 on the frame 10, against which a fourth rib 160 on the movable support means 12 abuts. The stopping is achieved by deformation, similar to clipping, of the fourth rib 160. The movable support means 12 moves relative to the frame by rotation about a hinge-type mechanism 17.

FIG. 5 illustrates a first alternative to the locking means for locking the movable support means of the fuel system component shown in FIG. 2 when the movable support means of the component is in the initial configuration. According to this first alternative, the movable support means 12 of the fuel system component 11 comprises a central part 120, preferentially in the form of a rod, a first end 121 suitable for interacting with an insertion means 2, such as an insertion rod, for example, and a second end (not shown) provided with an attachment means of the fuel system component. The first end 121 of the movable support means 12 is in the form of a rod-shaped extension of the central part 120 of the movable support means 12, the first end 121 and the central part 120 forming a 90° angle. The first end 121 bears against a part 20 of the insertion means 2, said insertion means 2 being inserted into the receiving member 14 of the frame 10, the receiving member being in the form of a sheath in which the insertion means 2 can slide. This arrangement of the first end 121 on the insertion means allows the movable support means to be rotated by gravity upon removal of the insertion means.

FIG. 6 shows a second alternative to the locking means for locking the movable support means of the fuel system component shown in FIG. 2 when the movable support means of the component is in the initial configuration. In this second alternative, the first end 121 of the movable support means 12 bears against the insertion means 2, said insertion means 2 being inserted into the receiving member 14 of the frame 10. The receiving member is in the form of a sheath in which the insertion means 2 can slide. The part 20 of the insertion member 2 against which the first end 121 of the movable support means 12 bears is in the form of a recess 200. This arrangement of the first end 121 on the insertion means allows the movable support means to be rotated by gravity upon removal of the insertion means. The presence of the recess 200 ensures more rigid positioning of the movable support means 12 when the device 1 is in the initial configuration.

FIG. 7 describes a third alternative to the locking means for locking the movable support means of the fuel system component shown in FIG. 2 when the movable support means of the component is in the initial configuration. According to this third alternative, the movable support means 12 comprises a central part 120, a first end 121 suitable for interacting with an insertion means 2, and a second end 122 provided with an attachment means (not shown) of the fuel system component 11. The first end 121 of the movable support means 12 is in the form of a rod-shaped extension of the central part 120 of the movable support means 12, the first end 121 and the central part 120 forming an angle smaller than or equal to 90°. The first end 121 is clipped onto a part 20 of the insertion means 2. The insertion means 2 is inserted into the receiving member 14 of the frame 10, the receiving member 14 being in the form of a sleeve in which the insertion means 2 can slide. The movable support means 12 is set in motion by the driving force of the movement to remove the insertion means 2. It can be seen that in this case, the movement is a rotational movement about a hinge-type mechanism 17, and this rotation resulting from an actuation mechanism of the movable support means 12 of the component 11 leads to an elevation of component 11 with respect to its initial position within the device.

FIG. 8 shows an embodiment of a device 1 for a plastic fuel tank for a motor vehicle according to the invention, the device 1 being assembled on an insertion means 2. The device comprises at least one frame 10, a fuel system component 11 and at least one movable support means 12 of the fuel system component 11, said movable support means 12 of the fuel system component 11 being attached to the frame and movable relative to the frame between an initial configuration in which the fuel system component is at a first distance, d₁, from the frame and a final configuration in which the fuel system component is at a second distance, d₂, from the frame, such that the first distance, d₁, is smaller than the second distance, d₂. The device shown in FIG. 8 is in the initial configuration. The frame 10 is provided with a means (not shown) for stopping the movement of the movable support means 12 of the fuel system component 11 when the movable support means 12 of the fuel system component 11 is in the final configuration. The component 11 of the fuel system is an internal reinforcing element 13 in the form of a diabolo 130 consisting of a central part based on a material selected from polyoxymethylene (POM), polyphthalamide (PPA), polyketone (PK), polyamide (PA), and metal, the two ends of the central part being overmolded with high-density polyethylene (HDPE). The frame 10 is in the form of a framework made of a material selected from polyethylene (PE), preferentially high-density polyethylene (HDPE), polyoxymethylene (POM), polyamide (PA), polyphthalamide (PPA), and polyketone (PK). The frame 10 also supports components of the fuel system such as vent lines, fuel lines, a pump, a level sensor, a pressure sensor, a temperature sensor, a quality sensor, a deflector, an internal reinforcing element 13 or a valve such as a flap, a roll-over valve (ROV) or a fill limit vent valve (FLVV). The frame 10 also includes a receiving member 14 suitable for receiving an insertion means 2, such as an insertion rod, for example. This receiving member 14 is preferentially in the form of a sheath in which the insertion means 2 can slide. The movable support means 12 of the fuel system component 11 comprises a rod-shaped central part 120, a first end 121 suitable for interacting with the insertion means 2, such as an insertion rod, for example, and a second end 122 provided with an attachment means 1220 of the fuel system component. The central part 120 of the movable support means 12 slides in a guide member 18 on the frame 10. This sliding of the central part 120 within the frame 10 induces a translational movement of the movable support means 12 relative to the frame 10. The translational movement is caused by the movement to remove the insertion means 2 by interaction between the first end 121 of the movable support means 12 and a part 20 of the insertion means 2. It is the shape of part 20 of the insertion means 2 that ensures the movement of the movable support means 12.

FIG. 9 shows the device 1 for a plastic fuel tanks for motor vehicles according to FIG. 8 in its final position. The device comprises at least one frame 10 in the form of a framework, a fuel system component 11 and at least one movable support means 12 of the fuel system component 11, said movable support means 12 of the fuel system component 11 being attached to the frame and movable relative to the frame. The frame 10 is provided with a means (not shown) for stopping the movement of the movable support means 12 of the fuel system component 11 when the movable support means 12 of the fuel system component 11 is in the final configuration. The component 11 of the fuel system is an internal reinforcing element 13 in the form of a diabolo 130 consisting of a central part based on a material selected from polyoxymethylene (POM), polyphthalamide (PPA), polyketone (PK), polyamide (PA), and metal, the two ends of the central part being overmolded with high-density polyethylene (HDPE). The frame 10 is in the form of a framework made of a material selected from polyethylene (PE), preferentially high-density polyethylene (HDPE), polyoxymethylene (POM), polyamide (PA), polyphthalamide (PPA), and polyketone (PK). The frame 10 also supports components of the fuel system such as vent lines, fuel lines, a pump, a level sensor, a pressure sensor, a temperature sensor, a quality sensor, a deflector, an internal reinforcing element 13 or a valve such as a flap, a roll-over valve (ROV), or a fill limit vent valve (FLVV). The frame 10 also includes a receiving member 14 suitable for receiving an insertion means 2, such as an insertion rod, for example. This receiving member 14 is preferentially in the form of a sheath in which the insertion means 2 can slide. The movable support means 12 for the fuel system component 11 comprises a rod-shaped central part 120, a first end 121 suitable for interacting with the insertion means 2, such as an insertion rod, for example, and a second end 122 provided with an attachment means 1220 for the fuel system component.

FIG. 10 illustrates a fourth alternative to the locking means for locking the movable support means of the fuel system component shown in FIG. 2 when the movable support means of the component is in the initial configuration. According to this fourth alternative, the movable support means 12 comprises a central part 120, a first end 121 suitable for interacting with an insertion means 2, and a second end 122 provided with an attachment means 1220 of the fuel system component 11. The first end 121 of the movable support means 12 is in the form of a rod-shaped extension of the central part 120 of the movable support means 12, the first end 121 and the central part 120 forming an angle of 180°. The first end 121 is attached to an actuator 21 on part 20 of the insertion means 2. The insertion means 2 is inserted into the receiving member 14 of the frame 10, the receiving member 14 being in the form of a sleeve in which the insertion means 2 can slide. The movable support means 12 is set in motion by the driving force of actuator 21 during the movement to remove the insertion means 2. In this case, the movement is translational, with the central part 120 sliding in a guide 18 on the frame 10.

FIGS. 11 and 12 illustrate, respectively, the step of inserting the device in the initial configuration within the tubular parison and the device in the final configuration within the tank. The distances d₁ and d₂ extend in a longitudinal plane (X; Y) of the device, relative to an axis L parallel to the longitudinal axis X of the device located in the longitudinal plane (X; Y). FIG. 11 shows the device according to the invention in an initial configuration, the insertion means is not shown, said device 1 is inserted within a tubular parison 3 extruded by means of an extrusion head 4, said device being in an initial configuration in which a component 11 of a fuel system is at a first distance, d₁, from a frame 10. The contour of the final tank 5 in which the device 1 is placed is shown for information. FIG. 12 shows the resulting tank 5, with device 1 in its final position. The fuel system component 11 is located at a second distance, d₂, from the frame 10, such that the first distance, d₁, is smaller than the second distance, d₂. This final configuration is reached by stopping the movement of the movable support means 12 of the component 11 by a stopping means on frame 10. The method described in FIGS. 11 and 12 solves the problem linked to the size of the device inserted within the tubular parison in relation to the diameter of the extruded parison. Indeed, the extruded tubular parison has a defined diameter. Extrusion constraints can change the shape of the parison and therefore its diameter. As a result, the device that can be inserted into the tubular parison must be inserted in a circle with a diameter smaller than the internal diameter of the tubular parison, which limits the positioning of the inserted components once the tank has been blown, the resulting tank having an internal cavity with dimensions greater than the internal diameter of the tubular parison. The device according to the invention solves this diameter reduction by avoiding the use of devices with smaller dimensions in order to have a safety clearance between the inserted device and the tubular parison, thus reducing the authorized dimensions of the inserted device (e.g., to 120 mm). As a result, the device inserted according to the invention meets the performance requirements of the product. In the case of pressure vessels, the internal reinforcing elements are positioned in the right place. For the ventilation system, the valves are located in such a way as to avoid any loss of useful volume.

1-15. (canceled)

16. A device for a plastic fuel tank for a motor vehicle, comprising:
at least one frame;
a fuel system component; and
at least one movable support means of the fuel system component, said movable support means of the fuel system component being attached to the frame and movable relative to the frame between an initial configuration in which the fuel system component is at a first distance from the frame and a final configuration in which the fuel system component is at a second distance from the frame such that the first distance is smaller than the second distance,
the frame being provided with means for stopping the movement of the movable support means of the fuel system component when the movable support means of the fuel system component is in the final configuration,
the fuel being gasoline, and
the fuel system component being an internal reinforcing element.

17. The device for the plastic fuel tank for the motor vehicle as claimed in claim 16, wherein the movable support means of the fuel system component is translationally and/or rotationally movable relative to the frame.

18. The device for the plastic fuel tank for the motor vehicle as claimed in claim 17, wherein the movable support means of the fuel system component is rotationally movable relative to the frame.

19. The device for the plastic fuel tank for the motor vehicle as claimed in claim 16, wherein the frame comprises locking means for locking the movable support means of the fuel system component so that the movable support means of the component is locked in the initial configuration.

20. The device for the plastic fuel tank for the motor vehicle as claimed in claim 16, wherein the movable support means of the fuel system component comprises a central part, a first end configured to interact with an insertion means, and a second end provided with an attachment means of the fuel system component.

21. The device for the plastic fuel tank for the motor vehicle as claimed in claim 20, wherein the central part is a rod and the insertion means is an insertion rod.

22. The device for the plastic fuel tank for the motor vehicle as claimed in claim 20, wherein the first end of the movable support means is configured to interact with the insertion means so that the removal of the insertion means causes the movable support means to move towards the final configuration.

23. The device for the plastic fuel tank for the motor vehicle as claimed in claim 16, wherein the frame comprises a receiving member configured to receive an insertion means.

24. The device for the plastic fuel tank for the motor vehicle as claimed in claim 23, wherein the insertion means is an insertion rod.

25. A method for manufacturing the plastic fuel tank for the motor vehicle, comprising:
extruding a tubular parison;
inserting the device for the plastic fuel tank for the motor vehicle as claimed in claim 16 within the tubular parison, said device being in the initial configuration in which the fuel system component is at the first distance from the frame;
deploying the device from the initial configuration in which the fuel system component is at the first distance from the frame to the final configuration in which the fuel system component is at the second distance from the frame, wherein the first distance is smaller than the second distance; and
stopping the deployment of the device when the device reaches the final configuration using the means for stopping provided on the frame.

26. The method for manufacturing the plastic fuel tank for the motor vehicle according to claim 25, wherein the inserting the device within the tubular parison is carried out using an insertion means.

27. The method for manufacturing the plastic fuel tank for the motor vehicle according to claim 26, wherein the insertion means is an insertion rod.

28. The method for manufacturing the plastic fuel tank for the motor vehicle according to claim 26, wherein the deploying the device from the initial configuration to the final configuration is carried out upon removal of the insertion means.

29. The method for manufacturing the plastic fuel tank for the motor vehicle according to claim 25, wherein the deploying the device from the initial configuration to the final configuration is carried out by rotating the movable support means of the component relative to the frame.

30. The method for manufacturing the plastic fuel tank for the motor vehicle according to claim 29, wherein the movable support means is rotated by gravity or by mechanical means upon removal of the insertion means.

31. The method for manufacturing the plastic fuel tank for the motor vehicle according to claim 25, wherein the deploying the device from the initial configuration to the final configuration is carried out by translating the movable support means of the component relative to the frame.

32. The method for manufacturing the plastic fuel tank for the motor vehicle according to claim 31, wherein the movable support means is translated by mechanical means upon removal of the insertion means.

33. The plastic fuel tank for the motor vehicle comprising:
the device for the plastic tank for the motor vehicle according to claim 16.
